(19) United States
(12) Patent Application Publication
(10) Pub. No.: US 2006/0186808 A1
(43) Pub. Date: Aug. 24, 2006

(54) Discharge lamp manufacturing method

(76) Inventors: Yuichiro Ogino, Takatsuki-shi (JP); Yoshimitsu Mino, Sourakugun (JP)

Correspondence Address: SNELL & WILMER L.L.P., 600 ANTON BOULEVARD, SUITE 1400, COSTA MESA, CA, 92626, US

(21) Appl. No.: 10/547,713

(22) PCT Filed: Mar. 10, 2004
(86) PCT No.: PCT/JP04/03066

§ 371 Date: Aug. 31, 2005

(30) Foreign Application Priority Data
Mar. 10, 2003 (JP) 2003-064044

(51) Int. Cl. H01J 9/00; H01J 17/20

(52) U.S. Cl. 313/574; 313/623; 445/26; 445/27

(57) ABSTRACT

In a discharge lamp manufacturing method according to which a pair of electrodes is formed by fusion cutting a predetermined part of a tungsten rod (16) disposed within a sealed arc space, the fusion cutting of tungsten rod (16) for forming a pair of electrodes is executed with the entire arc-tube part heated to a temperature at which at least an arc material that includes mercury (118) enclosed within the arc tube evaporates. This allows for the arc material within the arc space to evaporate sufficiently, and for the adhesion, to the inner wall of the arc tube, of tungsten electrode material that evaporates due to the fusion cutting by laser beam to be suppressed.

### TECHNICAL FIELD

The present invention relates to a manufacturing method for discharge lamps, and in particular to a manufacturing method for a short-arc discharge lamp whose interelectrode distance has been shortened to move the electrodes closer to the point light source.

### BACKGROUND ART

In recent years much research and development has gone into various types of projectors for realizing image display on large screens such as LCD (liquid crystal display) projectors and projectors using a DMD (digital micromirror device). Discharge lamps such as short-arc, high-pressure mercury lamps whose interelectrode distance has been reduced to 1.0 mm or less, for example, to move the electrodes closer to the point light source have been attracting attention as a possible light source for such projectors.

A manufacturing method for such discharge lamps disclosed in Japanese Patent No. 3,330,592, for example, involves inserting an electrode assembly that includes an electrode structural portion for forming a pair of electrodes for a discharge lamp into a glass bulb for a discharge lamp having an arc-tube part and side-tube parts and sealing the side-tube parts to thus form an arc tube having the electrode structural portion positioned therein, after which a pair of electrodes are formed within the arc tube by selectively fusion cutting a section (cutting site) of the electrode structural portion.

However, the inventors' investigations revealed that when the cutting site of the single tungsten rod included in the electrode structural portion was fusion cut using a laser beam, for example, the tungsten electrode material evaporates due to the rise in temperature when melting the tungsten rod, and adheres to the inner wall of the arc tube. While it may still be possible to clean the arc tube wall as a result of the action of the halogen enclosed within the arc tube (halogen cycle) by aging the discharge lamp prior to shipment, the adhesion of large amounts of tungsten may make it impossible to clean the arc tube sufficiently, raising fears about a deterioration in product yield. Note that the evaporation and adhesion of electrode material to the inner wall of the arc tube is not limited to when fusion cutting a single tungsten rod, and may also occur when irradiating a laser beam from outside the arc-tube part onto the discharge-side tips of electrode members (e.g. members having a coil-shaped member attached to the tip of an electrode rod) extending into the sealed arc space, to melt the tips.

The present invention, arrived at in view of the above problem, aims to provide a discharge lamp manufacturing method that enables the evaporation of electrode material and the adhesion of evaporated electrode material to an inner wall of the arc tube to be suppressed, with respect to the manufacturing of discharge lamps having electrodes formed by fusion cutting a single electrode rod and/or melting an electrode member within a sealed arc space.

### DISCLOSURE OF THE INVENTION

To achieve the above object, a first discharge lamp manufacturing method pertaining to the present invention involves an arc material and a pair of electrode members being introduced into a glass bulb having an arc-tube part and a side-tube part, the electrode member pair being secured by sealing the side-tube part, and a pair of electrodes being formed by melting at least part of the electrode member pair, with the at least part of the electrode member pair being melted with the arc material at least partially evaporated.

A second discharge lamp manufacturing method pertaining to the present invention involves an arc material and an electrode assembly that includes an electrode structural portion for forming a pair of electrodes being introduced into a glass bulb having an arc-tube part and a side-tube part, the electrode assembly being secured by sealing the side-tube part, and a section of the electrode structural portion being fusion cut to form the electrode pair, with the section of the electrode structural portion being melted with the arc material at least partially evaporated.

Note that “fusion cutting” refers to the separation of an electrode member by using heat to melt the electrode member. One specific method of fusion cutting involves, for example, melting an electrode member by using laser irradiation to apply heat, and then using the surface tension that occurs when the electrode member naturally cools after the laser irradiation has been stopped to cut the electrode member. However, the heating method is not limited to use of a laser beam. A variety of cutting methods are also conceivable, including the application of an impact force of some sort with the electrode member in a melted state.

With the discharge lamp manufacturing method of the present invention, the fusion cutting of a section of an electrode structural portion to construct a pair of electrodes or the melting of an electrode member is performed with the arc material at least partially evaporated. This not only allows the inside pressure of the arc-tube part to be raised and the evaporation of electrode material to be suppressed, but enables the adhesion of electrode material to the inner wall of the arc tube to be suppressed as a result of evaporated arc material particles colliding with the particles of electrode material that evaporate due to the fusion heat. Here “arc-tube part” refers mainly to the spherical section forming the arc space. Note that it is preferable to raise the temperature of both the spherical glass portion forming the arc space and an electrode portion exposed in the arc space.

Note that preferably all of the arc material is evaporated prior to the melting. When arc material (e.g., mercury) remains unevaporated, the rise in temperature during the melting causes the mercury to boil and thus contact with the melted electrodes, which may adversely affect the shape of the electrodes after processing. Naturally, partial evaporation may be satisfactory in the case of arc materials other than mercury.

Note that the discharge lamp manufacturing method may involve an arc material and a pair of electrode members being introduced into a glass bulb having an arc-tube part and a side-tube part, the electrode member pair being secured by sealing the side-tube part, and a pair of electrodes being formed by melting at least part of the electrode member pair, with a film of the arc material being formed on an inner wall of the arc-tube part prior to melting the at least part of the electrode member pair. Alternatively, the discharge lamp manufacturing method may involve an arc material and an electrode assembly that includes an electrode structural portion for forming a pair of electrodes being introduced into a glass bulb having an arc-tube part and a side-tube part, the electrode assembly being secured by sealing the side-tube part, and a section of the electrode structural portion being fusion cut to form the electrode pair, with a film of the arc material being formed on an inner wall of the arc-tube part prior to melting the section of the electrode structural portion.

The adhesion of electrode material to the inner wall of the arc tube part can also be greatly suppressed as a result forming this film.

In the case of the arc tube being formed from quartz glass, and the arc material being mercury, for example, the temperature of the arc-tube part when performing the fusion cutting or melting preferably is 1100° C. or below. The inventors' investigations revealed that the quartz glass recrystallizes over this temperature, resulting in the arc-tube part becoming opaque and cloudy. The interelectrode distance after formation of the pair of electrodes ideally is 4.5 mm or less (>0 mm).

### BRIEF DESCRIPTION OF THE DRAWINGS

FIG. 1 illustrates a manufacturing method for a discharge lamp in a preferred embodiment of the present invention;

FIG. 2 shows an arc tube 10 after the formation of sealing parts 20 and 20′;

FIG. 3 shows a discharge lamp 100 is which a pair of electrodes 12 and 12′ is formed inside arc tube 10;

FIG. 4 shows arc tube 10 when heated; and

FIG. 5 shows a laser beam being irradiated from outside of arc tube 10 with the arc tube in a heated state.

### BEST MODE FOR CARRYING OUT THE INVENTION

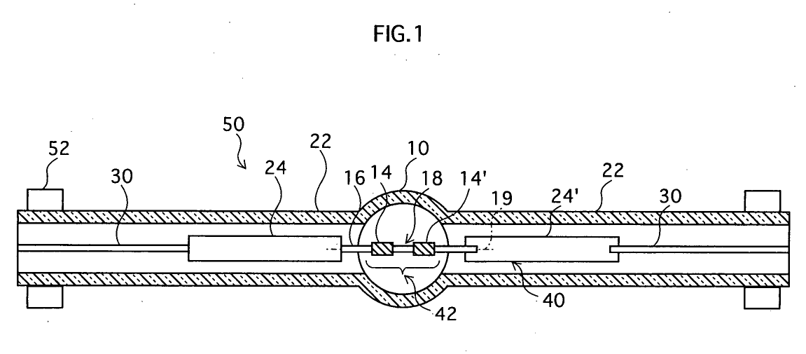

A preferred embodiment of a discharge lamp manufacturing method pertaining to the present invention is described below while referring to the drawings. FIGS. 1 to 3 illustrate a manufacturing method for a high-pressure mercury lamp as an exemplary discharge lamp manufacturing method pertaining to the preferred embodiment of the present invention.

With this embodiment, as shown in FIG. 1, a glass bulb 50 for use in a discharge lamp and a single electrode assembly 40 that includes an electrode structural portion 42 for forming a pair of electrodes in the discharge lamp are firstly prepared, after which electrode assembly 40 is inserted into glass bulb 50.

Glass bulb 50 has a substantially spherical arc-tube part 10 for forming an arc tube of a discharge lamp, and side-tube parts 22 extending from arc-tube part 10. A section of each side-tube part 22 is for forming a sealing part of a discharge lamp. Glass bulb 50 may be held in place by chucks 52, for example. In the present embodiment, glass bulb 50 is held in a horizontal position, but may be held in a vertical position.

Glass bulb 50 is constructed using quartz glass, for example, with an inner diameter of arc-tube part 10 of glass bulb 50 used in the present embodiment being 6.0 mm, a thickness of the glass being 3.0 mm, and each side-tube part 22 having an inner diameter of 3.4 mm and a longitudinal length of 250 mm. Electrode assembly 40 includes a tungsten rod 16 constituting electrode structural portion 42, and metal foils 24 and 24′ joined one at either end of tungsten rod 16. Metal foils 24 and 24′ can be constructed from molybdenum foil, for example. Tungsten rod 16 is to form the electrode axis of each of the pair of electrodes in the discharge lamp. Tungsten rod 16 has a length of approximately 20 mm and an outer diameter of approximately 0.4 mm, for example. A cutting site 18 to be cut in a later process is in a middle section of tungsten rod 16. Sections of tungsten rod 16 on either side of cutting site 18 are to form the tips of the electrodes, and in the present embodiment coils 14 and 14′ are attached respectively to these sections. Note that when attaching coils 14 and 14′ to tungsten rod 16, preferably tungsten rod 16 is pressure inserted into coils 14 and 14′ after firstly forming the coils so as to have an inner diameter smaller than the diameter of tungsten rod 16. This is to make the degree of adhesion between tungsten rod 16 and coils 14 and 14′ uniform, and thus avoid variations in the condition of the electrodes after processing using the same laser output, since the heat release of the coil sections is then substantially regular in the later process when laser irradiation is used to cut the cutting site. Naturally, the present embodiment is not limited to pressure insertion. For example, the inner diameter of coils 14 and 14′ may be enlarged and tungsten rod 16 attached to the coils using resistance welding after being inserted.

Coils 14 and 14′ function to prevent overheating of the electrode tips during lighting of a manufactured discharge lamp. The outer diameter of the section of electrode structural portion 42 to which coils 14 and 14′ are attached is approximately 1.4 mm, for example. Note that in the present embodiment, central axes 19 of the pair of electrodes can be aligned from the start because of electrode structural portion 42 for forming the pair of electrodes being constituted using a single tungsten rod 16. Tungsten rod 16 and metal foils 24 and 24′ are welded together. Metal foils 24 and 24′ may be flat rectangular sheets, for example, and the dimensions adjusted appropriately. Note that external leads 30 constructed from molybdenum, for example, are welded to metal foils 24 and 24′ at the ends opposite those at which tungsten rod 16 is joined.

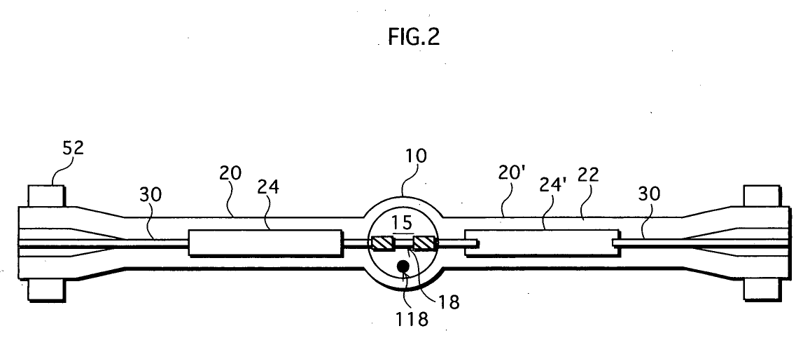

Electrode assembly 40 is inserted so that electrode structural portion 42 is positioned in arc-tube part 10 of glass bulb 50. Next, a seal is created between side-tube parts 22 of glass bulb 50 and sections (metal foils 24 and 24′) of electrode assembly 40 to form sealing parts 20 and 20′ (see FIG. 2) of the discharge lamp. Side-tube part 22 and metal foil 24 may be sealed in accordance with a known method. For example, the pressure within glass bulb 50 may be reduced (e.g., to 20 kPa) after firstly preparing the glass bulb for pressure reduction. A seal can then be created between side-tube part 22 of glass bulb 50 and metal foil 24 to form sealing part 20 by softening side-tube part 22 with a burner while at the same time rotating glass bulb 50 using chucks 52 under reduced pressure.

After forming sealing part 20, the arc material of the discharge lamp can be introduced relatively easily by introducing the arc material into arc-tube part 10 of glass bulb 50 prior to forming the other sealing part 20′. Of course, the arc material may be introduced through a hole opened in arc-tube part 10 after forming sealing parts 20 and 20′, and the hole closed off once the arc material has been introduced.

In the present embodiment, mercury 118 (e.g., approx. 150-200 mg/cm³) is introduced into arc-tube part 10 as arc material, in addition to 5-20 kPa of a rare gas (e.g., argon) and a small amount of a halogen (e.g., bromine). The halogen is not limited to a simple substance (e.g., Br₂), and can be enclosed using a halogen precursor, with bromine in the present embodiment being enclosed using a CH₂Br₂ compound. The role of the enclosed halogen (or a halogen derived from a halogen precursor) is to perform the halogen cycle during lamp operation.

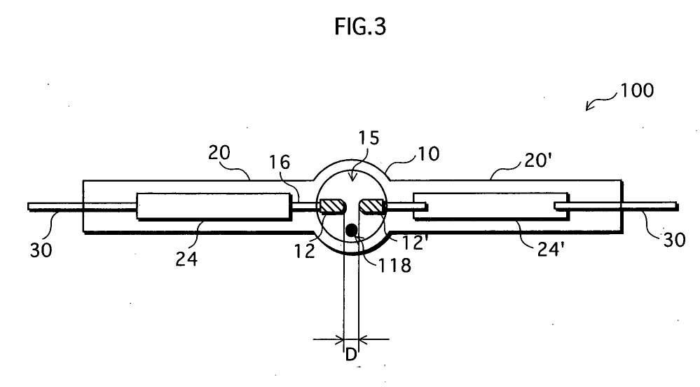

Arc tube 10 having electrode structural portion 42 disposed in an airtight arc space 15, as shown in FIG. 2, is obtained by forming sealing parts 20 and 20′. A pair of electrodes 12 and 12′ having a predetermined interelectrode distance D (see FIG. 3) can then be formed by selectively cutting the cutting site positioned within arc tube 10. In the present embodiment, the tips of electrodes 12 and 12′ are processed into a substantially semi-spherical or spherical shape by laser irradiation from outside of arc tube 10, as described in a later section. A discharge lamp 100 having the pair of electrodes 12 and 12′ formed within arc tube 10, as shown in FIG. 3, is then obtained by cutting glass bulb 50 so as to reduce sealing parts 20 and 20′ to a predetermined length.

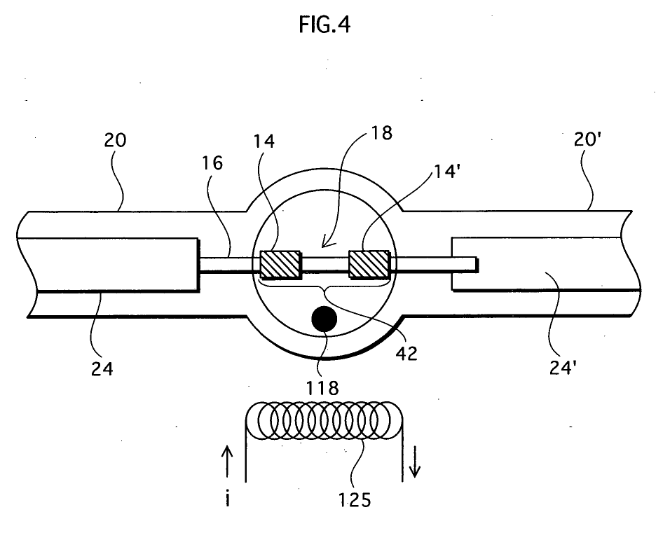

The discharge lamp manufacturing method of the present embodiment is characterized in that cutting site 18 is fusion cut after heating arc tube 10 to raise the temperature the arc tube and evaporating at least some of the arc material. FIG. 4 shows arc tube 10 when heated.

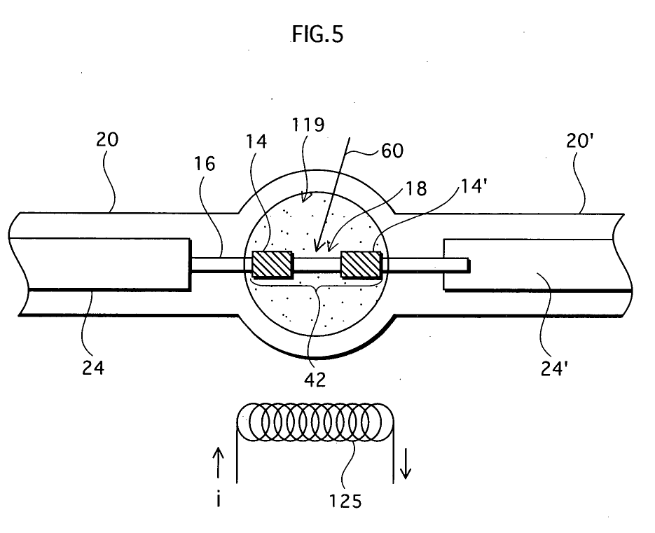

In the present embodiment, the temperature of the entire arc tube 10 is raised by passing electricity though a coil heater 125 disposed below arc space 15 as shown in FIG. 4 to heat the arc tube. Note that ideally the temperature of electrodes 12 and 12′ is also raised at this time, rather than only the glass portion structuring arc tube 10. FIG. 5 shows a laser beam 60 being irradiated toward cutting site 18 from outside of arc tube 10 with the arc tube in a heated state.

The reasons why the melting of cutting site 18 with the entire arc tube in a heated state enables the evaporation of tungsten electrode material and the adhesion of evaporated electrode material to the inner wall of the arc tube when performing fusion cutting to be suppressed are described below.

Firstly, the temperature of arc tube 10 is raised to evaporate mercury 118 enclosed as arc material in arc space 15 (see FIG. 4). Reference sign 119 in FIG. 5 represents the evaporated mercury particles.

This brings about a rise in pressure within arc space 15, and this rise in internal pressure enables the actual evaporation of electrode material to be suppressed. Also, even if evaporation of the electrode material does occur, the adhesion of tungsten to the inner wall of the arc tube is suppressed as a result of the evaporated tungsten particles colliding with evaporated mercury particles 119 within arc space 15 (see FIG. 5).

If the adhesion of electrode material to the inner wall of the arc tube is to be suppressed for the above reasons, the arc tube during the melting process preferably is heated to a temperature that allows at least some of the arc material enclosed in arc space 15 to evaporate, while keeping the pressure within the arc tube below the pressure resistance of the arc tube, even considering the internal pressure increases that result from the increase in temperature.

If mercury is used as arc material, as in the present embodiment, it is possible to arbitrarily regulate the post-heating temperature of the arc tube within a range that allows the mercury to evaporate, while keeping the pressure within the arc tube below the pressure resistance of the arc tube. Note that the temperature preferably is kept at or below 1100° C. This is due to the fact that the quartz glass structuring the arc tube may recrystallize at temperatures over 1100° C., becoming opaque and cloudy. Naturally, the preferable temperature range is changeable depending on such conditions as the type and amount of arc material used.

The application of a discharge lamp manufacturing method described above makes it possible to suppress the adhesion of electrode material to the inner wall of the arc tube and thus increase the yield during large-scale production, in the case of a pair of electrodes being formed by irradiating a laser beam onto a cutting site of an electrode assembly from outside.

Note that a discharge lamp manufactured using a manufacturing method of the present embodiment can be mounted to an image projection device such as an LCD projector or a projector using a DMD, for example, for use as the light source of the projector. This discharge lamp, apart from being used as a light source for projectors, can also be used as a light source in ultraviolet light steppers, sports stadiums, and car headlights etc.

Variations

The present invention, while having been described above based on a preferred embodiment, is naturally not limited to the specific examples shown in this embodiment. For example, the following variations are possible.

(1) In the preferred embodiment, a laser beam is irradiated onto cutting site 18 from outside the arc tube to perform fusion cutting. While laser irradiation is considered the most realistic method of fusion cutting a cutting site within a sealed arc tube, the present invention is not limited to this method. The use of induction heating, for example, is also considered possible.

(2) While the preferred embodiment, as shown in FIG. 4, is described in terms of coil heater 125 being provided in a vicinity of the arc tube to heat the entire arc tube, the heating method is not limited to this. A variety of heating methods are available including, for example, heating the arc tube using laser irradiation at an output that does not result in the cutting site being fusion cut, or passing the arc tube through a heated furnace.

(3) While the preferred embodiment is described in terms of tungsten rod 16 equating to the central axis of the pair of electrodes being used in electrode assembly 40, the use of a tungsten rod that does not have the same axis as the electrodes is also possible. Also, while electrode assembly 40 includes molybdenum foils 24 and 24′ joined to tungsten rod 16, the use of an electrode assembly in which molybdenum foils 24 and 24′ are also formed from the tungsten rod is also possible. In this case, leads 30 can also be constructed using the tungsten rod.

(4) In the preferred embodiment, a detailed description is given of the invention when applied in the manufacture of a discharge lamp (so-called super high pressure mercury lamp) in which the vapor pressure of the mercury enclosed as arc material is approximately 20 MPa. However, the possibility also exists of applying the present invention in relation to high-pressure mercury lamps having a mercury vapor pressure of approximately 1.0 MPa or low-pressure mercury lamps having a mercury vapor pressure of approximately 1.0 kPa. The present invention is also applicable in relation to discharge lamps other than mercury lamps, including metal halide lamps having a metal halide enclosed therein, for example. The optimizing of the temperature range when fusion cutting the cutting site is as described above.

(5) While the preferred embodiment is described in terms of fusion cutting a cutting site of an electrode assembly, the applicable scope of the present invention is not limited to this. The possibility also exists of applying the present invention in the case, for example, of attaching coil-shaped or cylindrical covering members to the discharge-side tips of a pair of separated electrode rods, inserting these structures via side-tube parts 22 and sealing the side-tube parts, before melting the electrode tips to form substantially semi-spherical or spherical shapes. Although available methods for melting the electrode tips in this case include making use of the heat in the electrode tips resulting from the discharge between the electrodes, and irradiating a laser beam from outside, application of the present invention enables the evaporation of electrode material and adhesion to the inner wall of the arc tube to be suppressed.

(6) While the electrode assembly in the preferred embodiment is melted after heating arc tube 10 to evaporate mercury arc material, a film of arc material may be formed over the entire inner wall of the arc tube prior to the melting process, in order to suppress the adherence of evaporated electrode material to the inner wall. One possible method of forming this film involves evaporating the arc material by firstly heating the arc tube, and then naturally cooling the arc tube.

(7) While the present invention is ideally applied in relation to short-arc discharge lamps having a relatively short interelectrode distance D (e.g., 0 mm<D≦4.5 mm, and preferably ≦2.0 mm), the present invention is by no means limited to this range. The present invention can also be applied in relation to direct-current discharge lamps, rather than only alternating-current discharge lamps.

### INDUSTRIAL APPLICABILITY

The discharge lamp manufacturing method pertaining to the present invention as described above enables the evaporation of electrode material and the adhesion of evaporated electrode material to the inner wall of the arc tube to be suppressed, because of an electrode assembly and/or electrode members being melted with the arc material at least partially evaporated, and is ideal for large-scale production of discharge lamps.

1. A discharge lamp manufacturing method according to which an arc material and a pair of electrode members are introduced into a glass bulb having an arc-tube part and a side-tube part, the electrode member pair is secured by sealing the side-tube part, and a pair of electrodes is formed by melting at least part of the electrode member pair, wherein
the at least part of the electrode member pair is melted with the arc material at least partially evaporated.

2. A discharge lamp manufacturing method according to which an arc material and an electrode assembly that includes an electrode structural portion for forming a pair of electrodes are introduced into a glass bulb having an arc-tube part and a side-tube part, the electrode assembly is secured by sealing the side-tube part, and a section of the electrode structural portion is fusion cut to form the electrode pair, wherein
the section of the electrode structural portion is melted with the arc material at least partially evaporated.

3. The manufacturing method as in claim 1, wherein all of the arc material is evaporated prior to the melting.

4. A discharge lamp manufacturing method according to which an arc material and a pair of electrode members are introduced into a glass bulb having an arc-tube part and a side-tube part, the electrode member pair is secured by sealing the side-tube part, and a pair of electrodes is formed by melting at least part of the electrode member pair, wherein
a film of the arc material is formed on an inner wall of the arc-tube part prior to melting the at least part of the electrode member pair.

5. A discharge lamp manufacturing method according to which an arc material and an electrode assembly that includes an electrode structural portion for forming a pair of electrodes are introduced into a glass bulb having an arc-tube part and a side-tube part, the electrode assembly is secured by sealing the side-tube part, and a section of the electrode structural portion is fusion cut to form the electrode pair, wherein
a film of the arc material is formed on an inner wall of the arc-tube part prior to melting the section of the electrode structural portion.

6. The manufacturing method as in claim 1, wherein the arc-tube part is made from quartz glass, the arc material includes mercury, and the temperature of the arc-tube part when performing the melting is 1100° C. or below.

7. The manufacturing method as in claim 1, wherein a laser beam is irradiated toward a predetermined position from outside the arc-tube part when performing the melting.

8. The manufacturing method as in claim 1, wherein an interelectrode distance is 4.5 mm or less (>0 mm).

9. The manufacturing method as in claim 2, wherein all of the arc material is evaporated prior to the melting.

10. The manufacturing method as in claim 2, wherein the arc-tube part is made from quartz glass, the arc material includes mercury, and the temperature of the arc-tube part when performing the melting is 1100° C. or below.

11. The manufacturing method as in claim 4, wherein the arc-tube part is made from quartz glass, the arc material includes mercury, and the temperature of the arc-tube part when performing the melting is 1100° C. or below.

12. The manufacturing method as in claim 5, wherein the arc-tube part is made from quartz glass, the arc material includes mercury, and the temperature of the arc-tube part when performing the melting is 1100° C. or below.

13. The manufacturing method as in claim 2, wherein a laser beam is irradiated toward a predetermined position from outside the arc-tube part when performing the melting.

14. The manufacturing method as in claim 4, wherein a laser beam is irradiated toward a predetermined position from outside the arc-tube part when performing the melting.

15. The manufacturing method as in claim 5, wherein a laser beam is irradiated toward a predetermined position from outside the arc-tube part when performing the melting.

16. The manufacturing method as in claim 2, wherein an interelectrode distance is 4.5 mm or less (>0 mm).

17. The manufacturing method as in claim 4, wherein an interelectrode distance is 4.5 mm or less (>0 mm).

18. The manufacturing method as in claim 5, wherein an interelectrode distance is 4.5 mm or less (>0 mm).
